(19) United States
(12) Patent Application Publication
(10) Pub. No.: US 2011/0068979 A1
(43) Pub. Date: Mar. 24, 2011

(54) REDUCING COMPLEXITY OF CALCULATIONS PERFORMED BY A NAVIGATION SYSTEM RECEIVER

(75) Inventors: Deric W. WATERS, Dallas, TX (US); Karthik RAMASUBRAMANIAN, Bangalore (IN); Ravi BHAT, Bangalore (IN)

(73) Assignee: TEXAS INSTRUMENTS INCORPORATED, Dallas, TX (US)

(21) Appl. No.: 12/890,031

(22) Filed: Sep. 24, 2010

Related U.S. Application Data
(60) Provisional application No. 61/245,551, filed on Sep. 24, 2009.

(51) Int. Cl. G01S 19/26

(52) U.S. Cl. 342/357.65

(57) ABSTRACT

In at least some embodiments, an electronic device includes a navigation system receiver and a receiver motion estimator coupled to the navigation system receiver. The receiver motion estimator determines and provides a receiver motion estimation to the navigation system receiver to reduce complexity of a satellite signal search operation performed by the navigation system receiver.

### CROSS-REFERENCE TO RELATED APPLICATIONS

This application claims priority to provisional application No. 61/245,551 filed Sep. 24, 2009 and entitled “Speed Estimation To Improve Acquisition For GNSS Receivers”. This priority document is incorporated herein by reference as if reproduced in its entirety.

### BACKGROUND

Global Positioning System (GPS) technology has various commercial applications, including navigation systems. Global Navigation Satellite System (GNSS) receivers make use of GPS technology to determine receiver position and subsequently can determine receiver speed and/or direction, or other parameters. Techniques to reduce the time required to acquire a position estimate are continually being sought.

One of the key metrics for GNSS receivers is the time to first fix (TTFF). Many ways to improve TTFF have been proposed, including providing assistance information to the GNSS receiver (e.g., assisted GPS techniques). When a GNSS receiver is acquiring satellite signals it searches over a three-dimensional space to locate at least four visible satellites and synchronize to them. The three dimensions are time, frequency, and satellite index. Efforts to reduce the search space (time, frequency, and/or satellite index possibilities) and thereby decrease the TTFF are ongoing.

### SUMMARY

In at least some embodiments, an electronic device includes a navigation system receiver and a receiver motion estimator coupled to the navigation system receiver. The receiver motion estimator determines and provides a receiver motion estimation to the navigation system receiver to reduce complexity of a satellite signal search operation performed by the navigation system receiver.

In accordance with at least some embodiments, a system includes a satellite search controller and a user motion estimator coupled to the satellite search controller. The satellite search controller reduces a satellite signal search space based on a user motion estimate provided by the user motion estimator.

In accordance with at least some embodiments, a method for determining a receiver position. The method includes receiving a receiver motion estimate and reducing a satellite signal search space based on the receiver motion estimate. The method also searching for a satellite signal using the reduced satellite signal search space. The method also includes performing said receiving and said reducing steps in parallel for multiple satellites until a sufficient number of satellite signals are acquired to determine the receiver position.

### BRIEF DESCRIPTION OF THE DRAWINGS

For a detailed description of exemplary embodiments of the invention, reference will now be made to the accompanying drawings in which:

FIG. 1 illustrates an electronic device in accordance with an embodiment of the disclosure;

FIG. 2 is a block diagram of a system in accordance with an embodiment of the disclosure;

FIG. 3 is a method in accordance with an embodiment of the disclosure; and

FIG. 4 illustrates an angle between the user-to-basestation line-of-sight (LOS) vector and the vector of user motion, the angle used for determining the user-to-basestation Doppler frequency caused by user motion in accordance with an embodiment of the disclosure.

### DETAILED DESCRIPTION

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

Embodiments disclosed herein are directed to techniques to efficiently search for a satellite signal in connection with a Global Positioning System (GPS) receiver or Global Navigation Satellite System (GNSS) receiver. In at least some embodiments, user motion information is provided to a GPS receiver or GNSS receiver to reduce a search space for satellite signal transmission time calculations and/or Doppler frequency calculations. With a reduced search space for satellite signal transmission time calculations and/or Doppler frequency calculations, satellite signals are acquired faster as is the receiver position—in other words decreasing time to first fix (TTFF). The techniques disclosed herein are combinable with other assisted techniques to reduce search space for a satellite signal. In addition to or separate from search space reduction based on user motion estimates, a GPS receiver or GNSS receiver may receive assisted information such as: approximate or precise GPS time; local oscillator offset information; predicted satellite Doppler; predicted satellite Doppler rate; the list of visible satellites; azimuth and/or elevation for visible satellites; approximate user position (such as nearest cell tower); satellite ephemeris information; satellite almanac information; satellite clock correction terms; predicted code-phase; predicted code-phase search window; navigation data bit timing information; and/or navigation data bits.

For clarity in describing the disclosed embodiments, a brief description of GNSS receiver processing is provided herein. The main purpose of the GNSS receiver is to determine the user's position, and estimating the user's velocity can help toward that end. To measure the user's position, the GNSS receiver needs to compute the “pseudorange” from a set of satellites to the user. The “pseudorange” refers to the geometric distance from user to satellite plus the effective distance due to receiver clock bias. An estimate of the receiver clock bias can be removed from the pseudorange to obtain an estimate of the geometric range from the user to the satellite. The user is then located on the surface of a sphere with a radius equal to the geometric range that is centered at the satellite. The intersection of the spheres from multiple satellites pin point the user position. The estimation of the clock bias and geometric range are interdependent, and are typically solved using iterative convergence techniques after at least four pseudoranges are measured. Measuring the user's velocity is similar in principle, but it is based on the rate of change in the pseudorange, which is proportional to the Doppler frequency.

In order to compute a pseudorange, the receiver first must synchronize to the arriving satellite signal. The signal is structured such that once the receiver has estimated the frame boundaries and bit edges of the signal it can determine the time the signal was transmitted. By subtracting this transmission time from the reception time (as reported by its own clock) the receiver obtains a pseudorange measurement.

The synchronization process generally involves performing correlations assuming a particular satellite's code, a hypothetical time delay, and a hypothetical Doppler frequency. Typically, many such hypotheses are tried before the correct one is found. In order to reduce the TTFF, assistance can provide a priori information regarding one or all of the dimensions being hypothesized. In the following discussion, it is assumed that time and frequency estimates are provided by means of assistance for each satellite. For example, the measured pseudorange can be written as:

$$\begin{matrix}{\tilde{ρ}}_{i} = c \cdot ( {t}_{Tx , i} - {t}_{Rx} ) \\ = c \cdot ( {t}_{P , i} - {t}_{CB} ) + {e}_{UserPos} + {e}_{t , i} + {e}_{t} \\ = {ρ}_{i} + {e}_{UserPos} + {e}_{t , i} + {e}_{t}\end{matrix} \qquad ( 1 \text{-} 1 )$$

where c is the speed of light, t_{Tx,i} is the transmission time from the i-th satellite, t_{Rx} is the received time according to the receiver's clock, t_{P,i} is the propagation time from the i-th satellite to the user, t_{CB} is the receiver clock bias, e_{t,i} corresponds to errors that are unique for each satellite, eₜ corresponds to clock errors that are common to all satellites, e_{UserPos} corresponds to errors due to unknown user position, and ρᵢ is the true pseudorange from the user to the i-th satellite. The assistance time would typically be an estimate of t_{P,i}.

There are three main error components in a Doppler frequency estimate:

\tilde{f}ᵢ=fᵢ+e_{UserVel}+e_{f,i}+e_{f} (1-2)

where e_{UserVel} is frequency error due to user movement, e_{f,i} is frequency error unique to each satellite, and e_{f} is frequency error common to all satellite signals. The assistance frequency would be an estimate of fᵢ. The size of the two dimensional (hypothetical time delay & Doppler frequency) search for a given satellite depends on the magnitude of the six errors described above. Generally speaking, the search must account for the maximum possible values of these errors to guarantee it synchronizes correctly. Namely, M≧max(|e_{UserVel,i}+e_{f,i}+e_{f}|) and N≧max(|e_{UserPos}+e_{t,i}+eₜ|). A statistical approach can also be used where M≧E (|e_{UserVel,i}+e_{f,i}+e_{f}|²)=E(|e_{UserVel,i}|²+|e_{f,i}|²+|e_{f}|² and N≧E(|e_{UserPos}+e_{t,i}+eₜ|²)=E(|e_{UserPos}|²+|e_{t,i}|²+|eₜ|²).

An example flow for the two-dimensional search for a given satellite is given in pseudocode below. The following two equations are used:

$$\begin{matrix}{f}_{m} = {f}_{A} + {( - 1 )}^{m} ⌈ \frac{m}{2} ⌉ Δ f & ( 1 \text{-} 3 ) \\ {t}_{n} = {t}_{A} + {( - 1 )}^{n} ⌈ \frac{n}{2} ⌉ Δ t & ( 1 \text{-} 4 )\end{matrix}$$

where f_{A} is the assistance frequency, and t_{A} is the assistance time.

| | |
|---|---|
| 1. | for each SV |
| 2. | Get the assistance time t_{A} and assistance Doppler frequency f_{A}. |
| 3. | for m=0 to M, |
| 4. | for n=0 to N, |
| 5. | Search bin at tₙ and fₘ. |
| 6. | if Correlation Peak is found |
| 7. | Declare this SV to be found. |
| 8. | SV differencing (optional) |
| 9. | Move to next SV. |
| 10. | end |
| 11. | Mark Bin(SV, n, m) as searched. |
| 12. | end |
| 13. | end |

14.end

So the time range in the search is set by the variables Δt and N, and the Doppler frequency range in the search is set by the variables Δf and M. The way that a correlation peak is declared “found” is a critical piece of the algorithm that can be done in various ways. For example, if the SNR>ThId, then declare the peak to be “found”.

Satellite differencing is a technique to leverage satellite signals already acquired to help find other satellite signals faster. This is possible because some of the largest errors are common to all the satellite signals; namely eₜ and e_{f}.

Without any assistance information M and N can be enormous, so assistance data is commonly used to reduce the search space (effectively reducing M and/or N). Even so, receivers still differentiate themselves based on how quickly they execute the search and locate the precise time and frequency for each satellite as well as how much computation power is required.

A numerical example is provided herein to demonstrate the impact on acquisition of time and frequency uncertainties. In this example, the uncertainty in the time assistance information comes from uncertainty due to the delivery of the time information from the assistance source, and errors due to the user's unknown position. Here σ_{UserPos}²=E[e_{UserPos}²] and σ_{time,i}²=E[|eₜ+e_{t,i}|²] are assumed. Then the total uncertainty in the time dimension is:

$${δ}_{TIME\_UNC , i}^{2} = \frac{{σ}_{UserPos}^{2}}{{( c / {10}^{6} )}^{2}} [ µs ] {cos}^{2} ( {φ}_{elev , i} ) + {σ}_{time , i}^{2} \qquad ( 1 \text{-} 5 )$$

There are Nᵢ bins to search in the time dimension for each hypothetical Doppler frequency of the i-th satellite. In this example, 2 bins per chip are assumed:

$${N}_{i} = {σ}_{TIME\_UNC , i} [ µs ] \times 2.046 [ \frac{bins}{µs} ] \qquad ( 1 \text{-} 6 )$$

The errors in frequency are assumed to be σ_{Dopp}_{_{—}}_{Vel,i}²==E[e_{UserVel,i}²] and σ_{Dopp}_{_{—}}_{Oscl}²=E[e_{f}²]. For simplicity it is assumed that e_{f,i}=0, which is not impractical since this error term is generally negligible compared to the others. The total Doppler frequency uncertainty is then:

σ_{Dopp,i}²σ_{Dopp}_{_{—}}_{Vel,i}²+σ_{Dopp}_{_{—}}_{Oscl}² (1-7)

where these two errors are quantified using two parameters:

$${σ}_{Dopp\_Vel , i} \leq 2.3 [ \frac{Hz}{mph} ] \times MaxUserSpeed [ mph ] , and {σ}_{Dopp\_Oscl} = 1575 [ \frac{Hz}{ppm} ] \times {σ}_{Ref\_Oscl} [ ppm ] .$$

The number of hypothetical Doppler frequencies that are required is defined as:

$${M}_{i} = \frac{{σ}_{Dopp , i}}{k} \times T \qquad ( 1 \text{-} 8 )$$

where σ_{Dopp,i} is the Doppler frequency uncertainty, T is the coherent integration interval, and k is a parameter to specify the overlap between Doppler frequency bins. A general rule of thumb is: 1≧k≧0.5. For high signal-to-noise ratio (SNR) satellites, T=0.001 seconds is possible, and in the absence of data-bit wipe-off assistance T≦0.02 seconds. So the following upper bound will be used:

$${M}_{i} < \frac{{σ}_{Dopp , i}}{25} . \qquad ( 1 \text{-} 9 )$$

Assuming σ_{UserPos}²=6 [km], σ_{time,i}²100 [μs], MaxUserSpeed=100 miles per hour, and σ_{Ref}_{_{—}}_{Oscl}=0.4 [ppm], then the size of the two dimensional search is defined by: N>208.7/Δt and M>670.7/Δf.

In accordance with at least some embodiments, user motion information is used to reduce the search spaces corresponding to M and N. The disclosed techniques are based on implementation of an independent user motion estimator that provides information about the user's movement, and can be used independently or jointly.

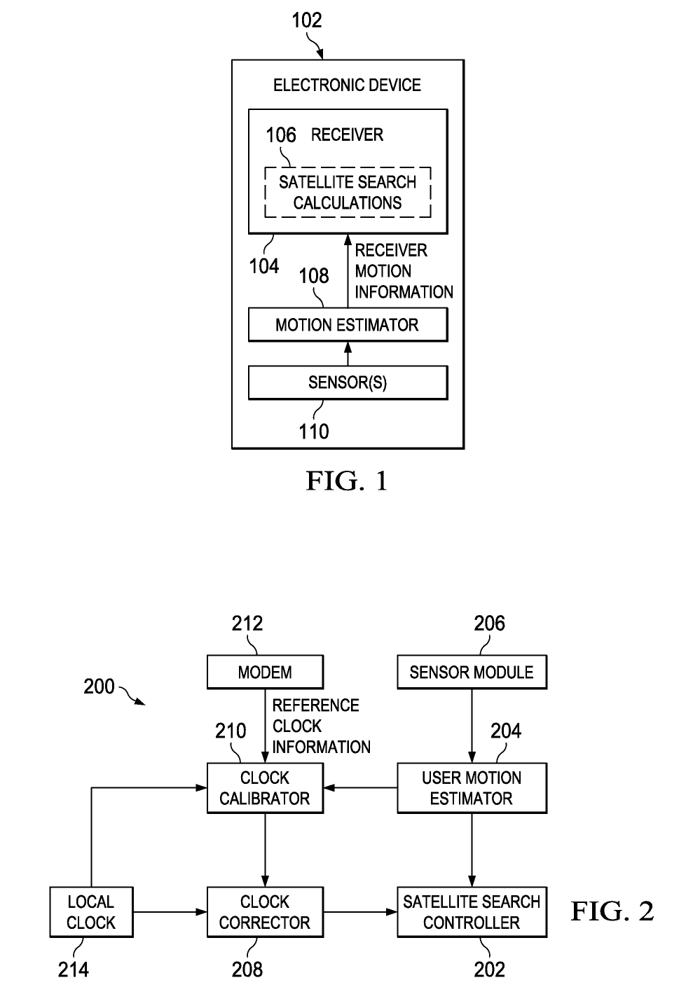

FIG. 1 illustrates an electronic device 102 in accordance with an embodiment of the disclosure. The electronic device 102 may correspond to a handheld device with GPS and/or navigation capabilities. Alternatively, the electronic device 102 may correspond to a vehicle-mounted device with GPS and/or navigation capabilities. As shown, the electronic device 102 comprises a receiver 104 coupled to a motion estimator 108. In at least some embodiments, the receiver 104 comprises a GNSS receiver configured to perform satellite signal search calculations 106 based on a receiver motion estimation received from the motion estimator 108. With the receiver motion estimation, the satellite search calculations 106 have a reduced complexity (e.g., a reduced search space resulting in faster TTFF).

In at least some embodiments, the electronic device 102 also may comprise sensor(s) 110 coupled to the motion estimator 108. The motion estimator 108 determines, for example, a receiver motion estimation based on a parameter value received from the sensor(s) 110. The parameter value corresponds to at least one of a speed value, an inertia value, a stationary detection value, a distance from a fixed point, a direction of motion, or other parameters. As an example, inertia measurements may be acquired using any combination (one or more) of an accelerometer, an e-compass, a gyroscope, or a pressure sensor. Meanwhile, the distance from a fixed point may be measured using a change in received signal strength indication (RSSI) or the propagation time of a signal to a fixed transmitter such as a WLAN access-point or a cell-phone tower. A speed measurement may be acquired using an odometer or other speed sensor (e.g., in a vehicle). Motion may alternatively be measured using visual data received from a camera in communication with the motion estimator 108. Further, motion estimator 108 may receive user input regarding the above parameter values. As a reference, various known motion determination techniques may be used such as those described in Käppi, J.; Syrjärinne, J.; and Saarinen, J., MEMS-IMU Based Pedestrian Navigator for Handheld Devices; ION GPS 2001, 11-14 Sep. 2001, Salt Lake City, Utah or in Chowdhary et al., Context Detection for Improving Positioning Performance and Enhancing User Experience; 22^{nd} International Meeting of the Satellite Division of The Institute of Navigation, Savanah, Ga.<Sep. 22-25, 2009.

The receiver (user) motion estimation provided by the motion estimator 108 to the receiver 104 for the satellite search calculations 106 may take any one of several forms. For example, a speed estimate may be a binary speed estimate (either zero or a default non-zero speed). Alternatively, the motion estimator 108 may provide a more detailed speed estimate (multi-bit levels). Further, the motion estimation may include speed only, or speed and direction of motion.

In at least some embodiments, the receiver 104 is configured to perform satellite search calculations 106 based on a receiver motion parameter. The satellite search calculations 106 may use a receiver motion parameter in relation to satellite signal transmission time uncertainty and/or Doppler frequency uncertainty as described herein. If there is no motion estimation (or the motion estimation falls outside a predetermined range), the receiver motion parameter for satellite signal search calculations 106 may be set by default to a worst case receiver speed value or worst case receiver displacement value. Alternatively, if the receiver 104 receives a motion estimation from the motion estimator 108, the receiver 104 is configured to replace the worst case receiver speed value (or worst case receiver displacement value) for the satellite search calculations 106 with a speed or displacement value associated with the received motion estimation.

The Doppler frequency is a function of the rate of change of the pseudorange between the receiver (user) and the satellite. Therefore, the receiver's speed and direction directly affects the Doppler frequency (after converting to the correct units by dividing by the wavelength). In at least some embodiments, the receiver motion parameter for the satellite search calculations 106 may be set such that the Doppler frequency search space covers a wide enough range of frequencies to include uncertainties in the user's speed. In other embodiments, the Doppler frequency search space can be constrained more accurately by taking the satellite elevation into account. The elevation can be computed given the receiver's location (within 10 kilometers accuracy or so), and the satellite position (e.g., via ephemeris or almanac). Given the elevation of the satellite, the impact of the user's speed in the horizontal plane on the Doppler frequency can be adjusted using the elevation of a satellite:

S_{UserVel,i}=cos(elevation of i-th satellite)S_{UserVel}

where S_{UserVel} is an upper bound on the user speed.

In some embodiments, the motion estimator 108 provides an estimated direction of motion. The effect of the user's speed on the Doppler frequency can be more accurately calculated by also including the difference between the direction of motion and the satellite azimuth.

S_{UserVel,i}=cos(β)cos(elevation of i-th satellite)S_{UserVel}

where β=azimuth of i-th satellite minus direction of motion or β=|azimuth of i-th satellite minus direction of motion|.

In at least some embodiments, the motion estimator 108 is implemented as a stationary detector. Regardless of the sensor(s) 110 used, if the motion estimator 108 detects a stationary receiver, motion estimator 108 may declares the receiver (user) to be stationary (S_{UserVel}=0). Stationary detection is an effective technique to reduce the number of satellite search calculations 106 performed by the receiver 104. In at least some embodiments, if the receiver 104 does not have any estimate of a receiver's motion, it can perform a two or three dimensional satellite search calculation by assuming the receiver 104 is stationary. Then if no correlation peaks are found, the receiver 104 may widen the search range without repeating the searches already performed. In other words, a search for satellite signals is performed (part of satellite search calculations 106) with a receiver motion parameter set to zero for a first search iteration and, as needed, is increased for each subsequent search iterations until a correlation peak is found (in other words until the satellite signal is acquired).

Regardless of how motion estimation is measured, in at least some embodiments, the receiver 104 is configured to perform a search for satellite signals (part of satellite search calculations 106) based on a Doppler frequency uncertainty calculation having a receiver motion parameter that is set by default to a worst case scenario. Thus, if there is no motion estimation (or the motion estimation falls outside a predetermined range) from the motion estimator 108, the receiver motion parameter for the Doppler frequency uncertainty calculation may be set by default according to the worst case user speed value. Meanwhile, if a motion estimation is received from the motion estimator 108, the receiver 104 is configured to replace the default worst case scenario value for the satellite signal search (part of satellite search calculations 106) with a speed value associated with the received motion estimation.

In at least some embodiments, the receiver 104 is configured to perform a satellite signal search (part of satellite search calculations 106) based on a time assistance uncertainty calculation having a receiver position parameter that is set to a worst case scenario. Thus, if there is no motion estimation (or the motion estimation falls outside a predetermined range) from the motion estimator 108, the receiver position parameter for the time assistance uncertainty calculation may be set by default to the worst case receiver displacement value. Meanwhile, if a motion estimation is received from the motion estimator 108, the receiver 104 is configured to replace the default worst case receiver displacement value for the time assistance uncertainty calculation with a displacement value associated with the received motion estimation (in other words by the distance the user moved since the last known position).

In at least some embodiments, the satellite signal search (part of satellite search calculations 106) performed by the receiver 104 may be based on a time assistance uncertainty calculations that account for ongoing clock drift of the receiver 104. The clock drift estimate for the receiver 104 is updated, for example, based on the motion estimation received from the motion estimator 108. Additionally or alternatively, once at least one satellite position has been acquired, it is possible to estimate the clock drift while the user is stationary using the following steps:

| | |
|---|---|
| 1. | Compute UserSpeed and convert to UserSpeedHz. |

| | |
|---|---|
| a. | Divide UserSpeed by wavelength in appropriate units. For GPS in L1 |
| | frequency band convert by multiplying user speed in mph by 2.3. |
| b. | In some embodiments the UserSpeed is reduced according to satellite |
| | elevation or satellite elevation, satellite azimuth, and user direction of |
| | motion as described above. |

| | |
|---|---|
| 2. | Compute UserPosChange [optional] |
| 3. | Compute M_{clock}=max(e_{f}), M_{UserVel}=UserSpeedHz, Mₐₛₛᵢₛₜ=max(e_{f,i}), |
| | N_{clock}=max(eₜ), N_{UserPos}=max(e_{UserPos}), Nₐₛₛᵢₛₜ =max(e_{t,i}). |
| 4. | Calibrate to a reference clock [optional] |

| | |
|---|---|
| a. | use UserSpeed to improve quality of the calibration. |

| | |
|---|---|
| 5. | Increase N_{UserPos} using UserPosChange. [optional] |
| 6. | Initialize the clock drift estimate, f_{CD} = 0 |
| 7. | for each satellite |

| | |
|---|---|
| 8. | Compute UserSpeedHz |
| 9. | Compute UserPosChange [optional] |
| 10. | Update M_{UserVel} and N_{UserPos} as necessary. |
| 11. | M = ceil( (Mₐₛₛᵢₛₜ + M_{clock} + M_{UserVel} )/Δf ) |
| 12. | N = ceil( (Nₐₛₛᵢₛₜ + N_{clock} + N_{UserPos} )/Δt ) |
| 13. | Get the center of time search t₀ = t_{A} |
| 14. | Get center for frequency search f₀ = f_{A} + f_{CD} |
| 15. | for m=0 to M, |
| 16. | for n=0 to N, |
| 17. | Search bin at time tₙ and frequency fₘ. |
| 18. | if Correlation Peak is found |
| 19. | Declare this satellite to be found. |
| 20. | f_{CD} = update estimate of clock drift [optional] |
| 21. | M_{clock} = 2*(uncertainty in f_{CD} ) / Δf [optional] |
| 22. | Move to next SV. |
| 23. | end |
| 24. | Mark Bin(SV, tₙ , fₘ ) as searched. |
| 25. | end |
| 26. | end |

27.end

where ceil(x)=smallest integer greater than x. Although the steps shown are performed sequentially, portions of the algorithm may be performed in parallel.

In at least some embodiments, the receiver 104 accounts for the frequency uncertainties by selecting an appropriately large range of frequencies around a received assistance frequency. For example, if the maximum frequency error due to the receiver clock is F_{clock} (in Hz), the maximum frequency error due to user movement is Fᵤₛₑᵣ (in Hz), and the maximum error in the assistance frequency is Fₐₛₛᵢₛₜ. Then the variable M in the search flow can be set greater than or equal to

$$\frac{1}{Δ f} \sqrt{{F}_{assist}^{2} + {F}_{UserVel}^{2} + {F}_{clock}^{2}} or \frac{1}{Δ f} ( {F}_{UserVel} + {F}_{assist} + {F}_{clock} )$$

so that the search covers the entire range of frequency uncertainty.

Because information from the motion estimator 108 can be used to reduce user speed along user-to-satellite line-of-sight (LOS), UserSpeed or M_{UserVel} in pseudocode, the acquisition search process can be performed faster. Specifically, the most reduction comes in the case that a stationary detector detects that the user is stationary and M_{UserVel} can be set to zero. Taking the numerical example above and assuming that user velocity does not contribute to the frequency error then the size frequency search can be reduced to M>630/Δf. This is a reduction of 6% in the search space compared to a default worst case scenario estimation. If the receiver has a priori knowledge of the receiver's position, for example from a previous estimate before re-acquisition started, and the receiver has an estimate of the maximum distance traveled since that estimation, then e_{UserPos} can be reduced. Of course knowing the direction of the receiver displacement could further improve the quality of the a priori receiver position and reduce e_{UserPos} more (it could even become satellite dependent). In the best case scenario, the user is known to be stationary since the last fix and e_{UserPos}=0. Instead of assuming a worst case receiver motion value, the dimension of the time search will be defined by N>204.6/Δt. This is a 2% reduction in the search space compared to a default worst case scenario estimation.

In practice, receivers sometimes synchronize their clock against a reference to improve its quality. Signals from cellular towers are a common example of a reference. In the context of the GPS synchronization, this reduces eₜ and e_{f} because during the calibration procedure, the quality of the calibration is hindered by uncertainty in the receiver's movement. Specifically, in an Assisted GPS context, the receiver's local clock (typically a TCXO) is calibrated against the cellular modem clock. If the modem is locked to the cellular network, then the process of calibration reduces the TCXO clock uncertainty to the order of 0.3˜0.5 ppm. This post-calibration uncertainty is usually comprised of the following components:
1) eBS=Basestation clock uncertainty of cellular basestation (+/−0.05 ppm);
2) eAFC=Uncertainty due to cellular modem AFC tracking loop (+/−0.05 ppm—implementation specific);
3) eUserMovement=User movement related (˜+/−0.3 ppm assuming say 100 m/s max user speed); and
4) eQ=Calibration quantization unc (+/−0.025 ppm)

If there is an independent motion estimator 108 as in electronic device 102, this uncertainty can be reduced. Specifically, the uncertainty eUserMovement above can be reduced. The parameter eUserMovement is set depending on the max user speed (higher max speed leads to larger values of eUserMovement). In the best case, if the user is stationary then eUserMovement is zero. Since the post-calibration uncertainty is dominated by user movement uncertainty, this has a significant impact on the clock synchronization. If the user is not stationary, the motion estimator 108 can provide a maximum speed so that eUserMovement can be set to cover the appropriate amount of uncertainty regarding the user max speed. Further improvements are possible if the motion estimator 108 provides a direction of motion and the position of the receiver relative to the base station is known—similar to utilizing satellite azimuth and direction of motion described above. This is because the speed along the line-of-sight (LOS) between the base station and user is most important and the max speed may be in any direction.

In FIG. 4, the line between a base station and user is drawn to represent the LOS path, and the angle θ is taken between the user's direction of motion and the LOS. In this case, if the user's max speed was 100 m/s then cos(θ)*100 is the user's speed towards the base station. Given an accurate estimate of the angle θ (which can be computed given the user's position relative to the base station and the user direction of motion) then the uncertainty in the clock synchronization due to user movement can be significantly reduced.

When calibrating the GPS clock using the cellular clock a procedure of counting clock edges is typically used. For example, a hardware circuit (e.g., clock calibrator 210 of FIG. 2) may count a certain duration of time (say 0.5 sec) based on counting the cellular clock edges. Within this same duration, the number of GPS clock edges is also counted by hardware (e.g., clock calibrator 210). Assuming the cellular clock is perfect (exactly at its nominal freq), the GPS clock frequency bias can be determined based on the calibration count value (e.g., the clock corrector 208 performs this step in FIG. 2). This estimate will have an uncertainty as described above involving eBS, eAFC, eUserMovement, and eQ. The uncertainty of the GPS clock frequency offset can be reduced by using a sensor-based estimate of user motion for eUserMovement instead of a default estimate (e.g., stationary or worst case scenario value).

FIG. 2 is a block diagram of a system 200 in accordance with an embodiment of the disclosure. As shown, the system 200 comprises a satellite search controller 202 coupled to a user motion estimator 204 and a clock corrector 208. The system 200 further comprises a local clock 214 and a clock calibrator 210 coupled to the clock corrector 208. In operation, the clock calibrator 210 receives reference clock (assistance time) information via modem 212 and provides a corresponding clock calibration signal to the clock corrector 208. The clock corrector 208 uses the clock calibration signal to modify the local clock signal from the local clock 214 and thus provide an updated local clock signal to the satellite search controller 202. In at least some embodiments, the clock calibrator 210 also may compute the uncertainty of the corrected clock (the updated local clock signal) and pass the uncertainty information to the satellite search controller 202. In accordance with at least some embodiments, the satellite search controller 202 performs satellite search operations based on the updated local clock signal from the clock corrector 208.

To summarize, the local clock signal provided to the satellite search controller 202 may be calibrated as described herein. If so, the uncertainty of the calibrated clock also may be provided to the satellite search controller 202. Further, the uncertainty of the calibration may be optionally reduced using the user motion estimate provided by the user motion estimator 204 (i.e., the uncertainty of the eUserMovement parameter is reduced). In at least some embodiments, the uncertainty calculation or at least reducing the uncertainty using the user motion estimate provided by the user motion estimator 204 may be omitted. In such embodiments, the user motion estimator 204 does not communicate with the clock calibrator 210 as is shown in FIG. 2. In such case, the user motion estimator 204 may still provide user motion information to the satellite search controller 202.

Furthermore, the user motion estimator 204 is configured to compute an estimate of user motion and an associated uncertainty thereof and passes the motion estimate and uncertainty information to the satellite search controller 202. In at least some embodiments, the user motion estimator 204 can also provide user motion information to the clock calibrator 210 to improve clock calibration. As shown in FIG. 2, the system 200 also comprises a sensor module 206 coupled to the user motion estimator 204. The sensor module 206 provides motion data or raw data to the user motion estimator 204.

In operation, the satellite search controller 202 takes the user motion estimates and uncertainty into account when computing M and N (related to estimating a satellite signal transmission time and a Doppler frequency for a satellite signal). With the user motion information, the satellite search controller 202 advantageously reduces an error (reducing the search space) for the satellite signal transmission time and the Doppler frequency.

In at least some embodiments, the user motion estimator 204 and the sensor module 206 may correspond respectively to the motion estimator 108 and sensor(s) 110 described for FIG. 1. Meanwhile, the satellite search controller 202 may correspond to the receiver 104 described for FIG. 1. Furthermore, the other components shown for system 200 may be integrated into a single device (e.g., electronic device 102) or spread across multiple units. Furthermore, one or more of the components shown for the system 200 may be combined. For example, the sensor module 206 may be combined with user motion estimator 204, the clock calibrator 210 may be combined with the clock corrector 208, and so on.

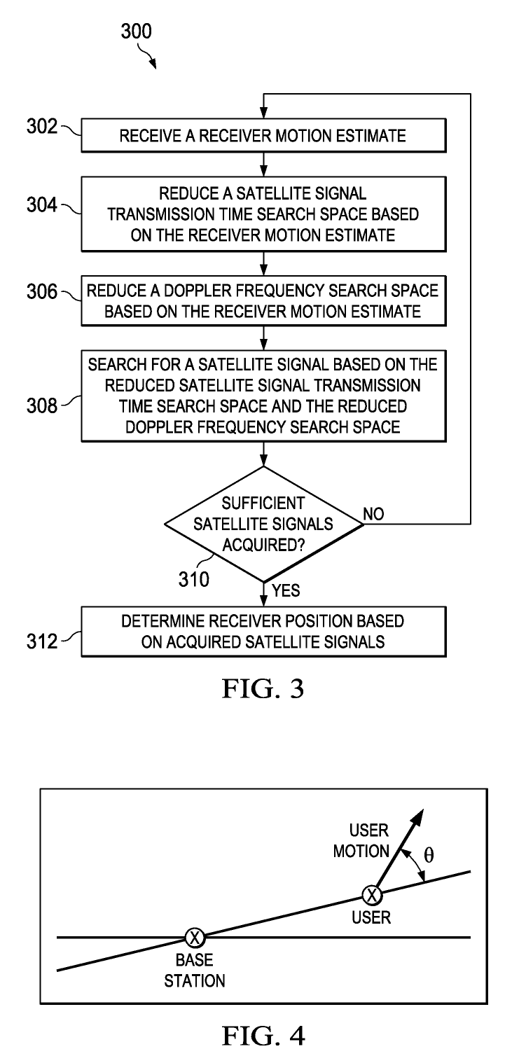

FIG. 3 is a method 300 in accordance with an embodiment of the disclosure. The method 300 may be performed, for example, by a GPS receiver or GNSS receiver. As shown, the method 300 comprises receiving a receiver motion estimate (block 302). At block 304, a satellite signal transmission time search space is reduced based on the receiver motion estimate. In at least some embodiments, reducing a satellite signal transmission time search space comprises calibrating a local clock signal based on the receiver motion estimate and searching for a satellite signal based on the calibrated local clock signal. Further, reducing the satellite signal transmission time search space may comprise replacing a worst case receiver displacement value with a sensor-based receiver displacement estimate. At block 306, a Doppler frequency search space is reduced based on the receiver motion estimate. The reduction of the Doppler frequency search space may comprise, for example, replacing a worst case receiver speed default value with a sensor-based receiver speed estimate.

As shown, the method 300 also comprises searching for a satellite signal based on the reduced satellite signal transmission time search space and the reduced Doppler frequency search space (block 308). In some embodiments, a satellite signal may be acquired by assuming a stationary receiver for a first satellite search iteration and incrementing a receiver speed estimate for each subsequent satellite search iteration until a correlation peak is found. If insufficient satellite signals have been acquired (e.g., less than 4) (determination block 310), the method 300 repeats steps 302, 304, 306 and 308 to acquire additional satellite signals. If sufficient satellite signals have been acquired (e.g., 4 or more) (determination block 310), the method 300 proceeds by determining a receiver position based on the acquired satellite signals (block 312). Although method 300 illustrates a sequential operation of satellite searches, some embodiments may perform satellite searches in parallel.

Many modifications and other embodiments of the invention will come to mind to one skilled in the art to which this invention pertains having the benefit of the teachings presented in the foregoing descriptions, and the associated drawings. For example, the Therefore, it is to be understood that the invention is not to be limited to the specific embodiments disclosed. Although specific terms are employed herein, they are used in a generic and descriptive sense only and not for purposes of limitation.

What is claimed is:

1. An electronic device, comprising:
a navigation system receiver;
a receiver motion estimator coupled to the navigation system receiver, wherein the receiver motion estimator determines and provides a receiver motion estimation to the navigation system receiver to reduce complexity of a satellite signal search operation performed by the navigation system receiver.

2. The electronic device of claim 1 further comprising a sensor coupled to the receiver motion estimator, wherein the receiver motion estimator determines the receiver motion estimation based on a parameter value received from the sensor.

3. The electronic device of claim 2 wherein the parameter value corresponds to at least one of a speed value, an inertia value, a direction of motion, and velocity.

4. The electronic device of claim 2 wherein the parameter value corresponds to a stationary detection value.

5. The electronic device of claim 2 wherein the parameter value corresponds to a distance from a fixed point.

6. The electronic device of claim 1 wherein the navigation system receiver is configured to perform the satellite search operation based on a Doppler frequency uncertainty calculation comprising a receiver motion parameter, wherein the receiver motion parameter is set by default to a worst case user speed value.

7. The electronic device of claim 6 wherein the navigation system receiver is configured to replace the worst case receiver speed value with a speed value associated with the receiver motion estimation.

8. The electronic device of claim 1 wherein the navigation system receiver is configured to perform the satellite signal search operation based on a time assistance uncertainty calculation comprising a receiver position parameter, wherein the receiver position parameter is set by default to a worst case receiver displacement value.

9. The electronic device of claim 8 wherein the navigation system receiver is configured to replace the worst case user displacement value with a displacement value associated with the receiver motion estimation.

10. The electronic device of claim 8 wherein the navigation system receiver is configured to perform the satellite signal search operation based on a receiver motion parameter, wherein the receiver motion parameter is set to zero for a first satellite signal search iteration and, as needed, is increased for each subsequent satellite signal search iteration until a satellite signal is found.

11. The electronic device of claim 1 wherein the navigation system receiver receives a reference clock signal to calibrate its local clock, and wherein a calibration uncertainty in said calibration is updated based on the receiver motion estimation, said calibration uncertainty being used to determine a time assistance uncertainty for the satellite signal search operation.

12. The electronic device of claim 1 wherein the receiver receives a reference clock signal to calibrate its local clock, and wherein an uncertainty in said calibration is updated based on the receiver motion estimation, said uncertainty being used to determine a Doppler frequency uncertainty for the satellite signal search operation.

13. A system, comprising:
a satellite search controller;
a user motion estimator coupled to the satellite search controller;
wherein the satellite search controller reduces a satellite signal search space based on a user motion estimate provided by the user motion estimator.

14. The system of claim 13 wherein the satellite search controller uses the user motion estimate to reduce at least one of a satellite signal transmission time search space and a Doppler frequency search space.

15. The system of claim 13 further comprising a clock calibrator coupled to the satellite search controller,
wherein the clock calibrator calibrates a local clock signal based on a reference clock, and
wherein an uncertainty of the calibrated local clock signal is reduced based on a user motion estimate provided by the user motion estimator,
wherein the calibrated local clock signal with reduced uncertainty is provided to the satellite search controller to reduce at least one of a satellite signal transmission time uncertainty and a Doppler frequency uncertainty.

16. The system of claim 13 further comprising a sensor module coupled to the user motion estimator, wherein the user motion estimator determines the user motion estimator value based on motion information received from the sensor module.

17. A method for determining a receiver position, comprising:
receiving a receiver motion estimate;
reducing a satellite signal search space based on the receiver motion estimate;
searching for a satellite signal using the reduced satellite signal search space;
performing said receiving and said reducing steps in parallel for multiple satellites until a sufficient number of satellite signals are acquired to determine the receiver position.

18. The method of claim 17 wherein reducing a satellite signal search space based on the receive motion estimate comprises reducing at least one of a signal transmission time search space and a Doppler frequency search space.

19. The method of claim 17 wherein reducing the satellite signal search space comprises calibrating a local clock signal based on a reference clock and reducing an uncertainty of the calibrated local clock signal based on the receiver motion estimate.

20. The method of claim 17 wherein searching for a satellite signal comprises assuming a stationary receiver for a first satellite search iteration and incrementing a receiver motion estimate for each subsequent satellite search iteration until a correlation peak is found.
